(19) United States
(12) Patent Application Publication
(10) Pub. No.: US 2010/0324808 A1
(43) Pub. Date: Dec. 23, 2010

(54) MOTORISED VEHICLE WITH CONTROLLED INCLINATION

(76) Inventors: Daniel Moulene, Villennes Sur Seine (FR); Thierry Moulene, Courbevoie (FR)

Correspondence Address: OLIFF & BERRIDGE, PLC, P.O. BOX 320850, ALEXANDRIA, VA, 22320-4850, US

(21) Appl. No.: 12/918,409

(22) PCT Filed: Mar. 2, 2009
(86) PCT No.: PCT/IB09/00400

§ 371 Date: Aug. 19, 2010

(30) Foreign Application Priority Data
Feb. 29, 2008 (FR) 08/01139

(51) Int. Cl. G06F 19/00

(52) U.S. Cl. 701/124

(57) ABSTRACT

The motor vehicle of the invention is provided with at least three wheels and includes a driving cab capable of accommodating a single person in the width direction. The motor vehicle comprises a bend-balancing means that acts by the inclination of at least the portion of the chassis that bears the driving cab. According to the invention, the vehicle is also provided with speed, acceleration and/or inclination sensors, and the balancing means are automatically controlled when the information supplied by the sensors is lower than a main predetermined threshold. The invention also provides that the automatic control of the balancing means is deactivated when the information provided by the sensors is higher than said main threshold.

The present invention relates to motorised vehicles with more than two wheels, such as those which are designed for use preferably, but not exclusively, in an urban area: for example scooters, motorcycles, or other narrow vehicles.

More specifically it relates to a vehicle of this type comprising a driver's seat contained in a driving cab with dimensions such that it can accommodate only a single person in the width direction. This type of vehicle thus takes up less space when it is parked, and can travel more easily in traffic, in particular in urban traffic, and takes up less space on the road.

Some of these vehicles comprise means for balancing on bends or on ground which is inclined relative to the horizontal. These balancing means act in particular by inclination of the vehicle chassis (which itself is connected to the driving cab), and sometimes involve simultaneous inclination of all or some of the vehicle wheels. In manual versions of the vehicle, they are controlled exclusively by the driver alone, and in automatic versions of the vehicle, they are controlled exclusively by a dedicated automatic device which for example comprises an electric actuator or a hydraulic device.

Permanent automatic control of these balancing means by means of an electric or hydraulic actuator requires use of an actuator with relatively high power, which increases the cost of the vehicle, all the more so since the use of a high-power actuator requires supply of energy which is also relatively high, which then also has the consequence of increasing the size, weight, and therefore the cost of the vehicle, as well as its energy consumption, and consequently of limiting this automatic control to vehicles which are expensive and/or have a high power level.

The invention relates to a vehicle of the above-described type, and proposes that the balancing means be controlled, or not controlled, alternatively, by an automatic device, according to the travel conditions of the vehicle.

More specifically, the invention proposes that the vehicle balancing means act by inclination of at least part of the chassis which supports the driver, and are controlled automatically when at least one of the parameters out of, in particular, the speed, acceleration or inclination of the vehicle (or a combination of at least two of these parameters) is lower than a predetermined main threshold, and that they can be controlled by means other than fully automatic ones when this parameter (or, the aforesaid combination of all or part of these parameters) is higher than the same predetermined main threshold. Advantageously, in this last case, these balancing means can then be controlled by the driver alone, with or without assistance.

For the purposes previously described, according to one of its characteristics, the vehicle according to the invention thus comprises firstly one or a plurality of sensors for speed, acceleration and/or inclination. It also comprises means for automatic control of the balancing means, when the information which is provided by this/these sensor(s) is below a predetermined main threshold, as well as switching means which permit deactivation of the automatic control of the balancing means, when the information which is provided by this/these sensor(s) is above this same threshold. In this case, and in the remainder of the text, “information which is provided by the sensors” means the value of one or a plurality of parameters measured by the different sensors, or any combination of all or some of the values of the parameters measured by these sensors.

According to the invention, other types of sensors can advantageously replace, or be associated with, the sensors previously described, for example a sensor for the steering moment of the steering control means, gyroscopes, accelerometers, etc.

The possibility by means of the aforementioned switching means of deactivating the automatic control of the vehicle balancing means makes it possible to limit the size and weight of the actuator necessary for the automatic control of these means, whilst maintaining the possibilities of balancing of the vehicle according to, the needs imposed by driving, and whilst maintaining the driving comfort provided, for example at low speed, by the automatic control of these balancing means. This results in limitation of the weight and therefore of the cost of the vehicle, for the same driving comfort.

According to a preferred embodiment of the invention, the balancing means are automatically controlled when the vehicle is started, and until the sensor(s) provide(s) information which is higher than the predetermined main threshold previously referred to. Outside the starting phases, the balancing means are also automatically controlled when the said sensor(s) provide(s) information which is lower than the main threshold, and continue to be controlled automatically for as long as the information which is provided by the said sensor(s) is lower than this main threshold.

According to another characteristic of the preferred embodiments of the invention, the balancing means are also automatically controlled when, with the vehicle travelling in conditions in which the information provided by the sensor(s) is higher than the main threshold, this information becomes lower than a descending main threshold, and remains lower than the main threshold. In other wards, for example when the information which is provided by the sensor is, by way of non-limiting example, speed information, the balancing means are automatically controlled when the vehicle starts, and its speed remains lower than the main threshold, when the vehicle is travelling at a speed lower than the main threshold, and when, with the vehicle travelling at a speed higher than this main threshold, it decelerates until it reaches a descending main threshold: in this case, the balancing means are automatically controlled for as long as the vehicle speed remains lower than the main threshold. In other words, the main threshold below which the balancing means are automatically controlled has a hysteresis. The foregoing information shows that the main threshold is advantageously higher than the descending main threshold.

Advantageously, the vehicle according to the invention also comprises means for positioning to the vertical level (or to a position which is very close to the vertical level) when it is at a standstill, or is at very low speed when it is close to stopping, or when it is reversing. The vehicle according to the invention thus also comprises means for detection of the vertical position.

These means which bring the vehicle to the vertical position (or to a position which is very close to the vertical level) are particularly useful, for example, in order to allow the driver to avoid having to stabilise the vehicle when it is at a standstill, for example by using his feet, as he would do with a conventional two-wheeled vehicle. They also prevent the vehicle from remaining in a position of inclination relative to the vertical level when the stoppage occurs. Additionally, they advantageously prevent any untimely inclination of the vehicle, in particular during parking manoeuvres (carrying out a parking manoeuvre in a gap, for example), or when the vehicle is travelling at a very low speed, for example in order to access a parking space which is narrow and/or surrounded by walls. They therefore guarantee comfortable parking, even on ground which is uneven, or on a slope.

According to the invention, the means for positioning to the vertical level (or in a position very close to the latter) are advantageously substantially active when the vehicle is at a standstill, or when the vehicle is reversing, as well as when the means for balancing of the vehicle are controlled automatically.

According to a characteristic of the vehicle according to the invention, the means for positioning of the vehicle to the vertical level are controlled automatically when the information which is provided by the above-described sensor(s) is lower than a previously defined vertical maintenance level (and in particular when the vehicle is at a standstill or close to a standstill), and are automatically deactivated when the information which is received from the above-described sensor(s) is higher than the aforementioned vertical maintenance threshold.

According to another characteristic, of the invention, like the main threshold, the vertical maintenance threshold has a hysteresis. In other words, when the information which is provided by the sensor(s) is, by way of non-limiting example, speed information, the means for positioning to the vertical level are automatically controlled when the speed is lower than the vertical maintenance threshold, as well as when, with the vehicle travelling at a speed higher than this threshold, it decelerates until it reaches a descending vertical maintenance threshold: the means for positioning to the vertical level are then automatically controlled for as long as the vehicle speed remains lower than the vertical maintenance threshold. The foregoing information shows that the descending vertical maintenance threshold is advantageously lower than the vertical maintenance threshold.

In addition, according to one of the preferred embodiments of the invention, the vehicle comprises a manual vertical position switch which, in its active state, automatically controls the means for positioning to the vertical level or to a position close to the vertical level, even if the information which is received from the sensor(s) is higher than the vertical maintenance threshold. This functionality provides the vehicle according to the invention with an additional advantage in terms of driving comfort, in particular in the case in which this vehicle is manoeuvring between other vehicles in traffic, or when it is travelling along a wall, or when it is carrying out parking manoeuvres on a slope, wherein the driver may be required to apply acceleration which leads the vehicle to reach a speed which for example is higher than the vertical maintenance threshold speed. The possibility of using the manual vertical position switch then allows the user of the vehicle according to the invention to force the latter into its vertical position, or close to the vertical level, for maximum driving comfort.

According to different embodiments of the invention, the vertical maintenance threshold can be identical to the main threshold, or it can be different from the latter. In this case, it is preferably lower than the main threshold.

According to another characteristic of the invention, the vehicle also comprises means for locking in its vertical position, or in a position which is very close to the vertical level, when it is at a standstill.

Advantageously, the vehicle according to the invention comprises means for limitation of its inclination to a predefined angle, such that, when it is at a standstill for example, even in the event of failure of the means for positioning and maintenance at the vertical level, the vehicle does not tilt.

Advantageously, the vehicle according to the invention also comprises means for locking of its inclination at a maximum predefined inclination, which is fixed, or in particular is dependent on its speed.

These means prevent the vehicle from inclining beyond the maximum predefined value, when the vehicle is engaged, for example at a relatively high speed, on a pronounced bend. In this case, when the inclination of the vehicle reaches the said predefined maximum value, the said means for locking the inclination will prevent the vehicle from inclining further, even when the balancing means would have tended to command a greater inclination. Contrary to a simple stop, these locking means prevent the vehicle from overturning on the centripetal force side, which then tends to straighten it towards the interior of the bend. These locking means are designed such that the mechanics by means of which the inclination of the vehicle is obtained are simple and reliable.

Advantageously, a computer assures the automatic control of the means for limitation of the inclination, the means for locking the inclination, or both at the same time, depending on the information which is provided by the sensor(s). In particular, the computer comprises means for determination of the maximum angle of inclination, according in particular to the speed and/or acceleration of the vehicle: this maximum angle of inclination will advantageously be smaller in relation to the vertical level when the, vehicle is in a situation of travel at a low speed and/or with low acceleration, than when the same vehicle is travelling at a high speed and/or with high acceleration.

According to the invention, the means for limitation of the inclination are controlled automatically, irrespective of the state of control of the balancing means previously described. In other words, according to the invention, the control of the means for limitation of the inclination of the vehicle is independent from the control of the means for balancing of the latter, even if the computer which controls them is included in the automatic control device previously described for the said balancing means.

According to an advantageous embodiment of the invention, the main threshold is different, depending on whether the aforementioned switching means are in their state in which the balancing means are automatically controlled (acceleration), or whether they are in their state in which they permit deactivation of the automatic control of the balancing means (deceleration), and thus have a hysteresis.

Preferably, the threshold beyond which the said switching means permit deactivation of the automatic control of the balancing means is slightly higher than the threshold below which the said communication means are in their state in which the balancing means are automatically controlled.

By this means, when the vehicle is in conditions in which the switching means permit deactivation of the automatic control of the balancing means, for example at low speed after starting, the threshold below which the said switching means are in their state in which the balancing means are automatically controlled is firstly cleared, before the threshold beyond which the said switching means permit deactivation of the automatic control of the balancing means is cleared. Thus, the switching means are not liable to give rise to an excessively immediate succession of automatic control of the balancing means, and authorisation for deactivation of the latter.

In order to improve further the comfort and stability of the vehicle, in addition to the above-described means the invention includes additional means which will be described hereinafter, and which make it possible to modify the sensitivity of the inclination of the inclinable part of the vehicle, and all or some of its wheels, to the predefined movement of the aforementioned steering unit (steering wheel, handlebar, etc).

According to one embodiment of the invention, the vehicle comprises a torsion bar which is associated with the unit for control of steering of the vehicle, steering wheel or handlebar. Advantageously, this torsion bar is rendered integral with the unit for control of steering of the vehicle.

Advantageously, according to one of the particular embodiments of the invention, beyond a previously defined threshold value of the speed, acceleration or inclination of the vehicle, slight separation takes place between the steering control unit of the vehicle and the guiding wheels.

For this purpose, the invention comprises means for partial separation of the wheels from the unit for control of steering of the vehicle, over a predetermined steering angle.

According to one of its particular embodiments, the vehicle according to the invention advantageously comprises additional means which control automatically the means for partial separation of the wheels, when the information which is provided by the sensor(s) previously described is higher than a previously defined threshold for partial separation of the wheels. These additional control means also prevent automatically the automatic control of the means for partial separation of the wheels of the vehicle, when the information which is received from the aforementioned sensor(s) is lower than the said threshold for partial separation of the wheels.

For this purpose, advantageously, according to the invention, the force to be exerted on the steering unit (typically the steering wheel) in order to obtain a given variation of trajectory or inclination of the vehicle, is greater than the force to be provided in order to obtain the same variation or inclination at a speed, acceleration or inclination lower than the said threshold for partial separation of the wheels.

For this purpose, the vehicle according to the invention is advantageously provided with means for hardening of the steering of the vehicle, which impose the aforementioned increase in force, beyond the aforementioned threshold value, which is also known as the hardening threshold.

The means for hardening the steering of the vehicle can be constituted by a torsion bar, which is associated or rendered integral with the means for controlling the steering of the vehicle.

These hardening means can be provided by means of assisted steering with variable assistance, which, at low speed, makes the steering easier, and, at high speed provides the required hardening. In the case of electrical assistance in particular, the latter is advantageously programmed to follow a law which is finer than a simple triggering threshold. This prevents the driver from perceiving changes of performance, and allows his driving sensations to be improved.

According to one of the characteristics of one of its particular embodiments, the vehicle according to the invention then advantageously comprises means for automatic control of these means for hardening of the steering. According to an additional characteristic of the invention, the means for hardening the steering are thus automatically controlled as soon as the information which is received by the aforementioned sensors is higher than the previously defined hardening threshold.

According to different embodiments of the invention, this hardening threshold can be equal to the main threshold previously described, or different from the latter. In this last case, it is advantageously higher than the main threshold.

It should be noted that the means for hardening of the steering can also act on the basis of information which is provided by moment sensors, and by modifying the moment to be exerted on the steering unit in order to obtain a given displacement of the latter.

Advantageously, according to one of the embodiments of the invention, beyond a previously defined modification threshold of one or a plurality of the parameters measured by the sensors, the variation of the inclination of the vehicle obtained for a given movement of the steering unit is greater than the variation of inclination of the same vehicle for the same movement of the steering unit carried out when these parameters are below this variation threshold. In other words, in the case in which the parameter concerned is, by way of non-limiting example, the speed of the vehicle, a single movement of the steering unit will give rise at high speed to inclination of the vehicle which is greater than the inclination of the vehicle obtained with the same movement of the steering unit at low speed.

The vehicle according to the invention then advantageously comprises means for modification of the law which connects the movements of the steering unit to the movements of the chassis.

According to one of its characteristics in one of its particular embodiments, the vehicle according to the invention then also comprises means for automatic control of these modification means, when the aforementioned modification threshold is exceeded. According to an additional characteristic of the invention, the means for modification of the law which connects the movements of the steering unit and the movements of the chassis are thus controlled automatically when the said modification threshold is reached.

According to different embodiments of the invention, the modification threshold can be equal to the aforementioned main threshold, or to the hardening threshold previously described, or it can be different from these values. In this case, it is advantageously higher than the main threshold.

It should be noted that the above-described non-limiting means (hardening of the steering, modification of the law which connects movements of the steering unit and movements of the chassis) can be implemented simultaneously.

It should also be noted that these means, which, as indicated by the foregoing information are preferably implemented beyond the main threshold, can be used as means for assistance in driving the vehicle according to the invention, in particular when the deactivation of the automatic control of the means for balancing of this vehicle is authorised (i.e. beyond the main threshold).

According to a variant of the invention, when the automatic control of the balancing means is deactivated, part of the energy is supplied by the actuator of the automatic control device of the balancing means, to aid or assist the force which the driver must apply in order to incline or straighten the vehicle.

According to the invention, in order to increase further the comfort and safety of the vehicle, there are particular arrangements which will now be described in greater detail.

According to one of the aforementioned arrangements, a door for access to the driving cab is installed on both sides of the latter. This facilitates access to the driver's seat irrespective of the parking position of the vehicle, including when the latter has stopped against a wall, and therefore increases the possibilities and comfort of use of this vehicle.

According to, one of these arrangements, the roof of the bodywork which forms a structure for protection of the driver comprises an opening panel. According to different, non-limiting embodiments of the invention, this panel can pivot around an axis which is substantially parallel or perpendicular to the longitudinal axis of the vehicle, or it can slide according to the longitudinal direction of the vehicle.

Advantageously, the different elements which constitute the lateral door(s) and the opening or mobile roof panel can be opened and closed separately or together in groups of two or three at the same time.

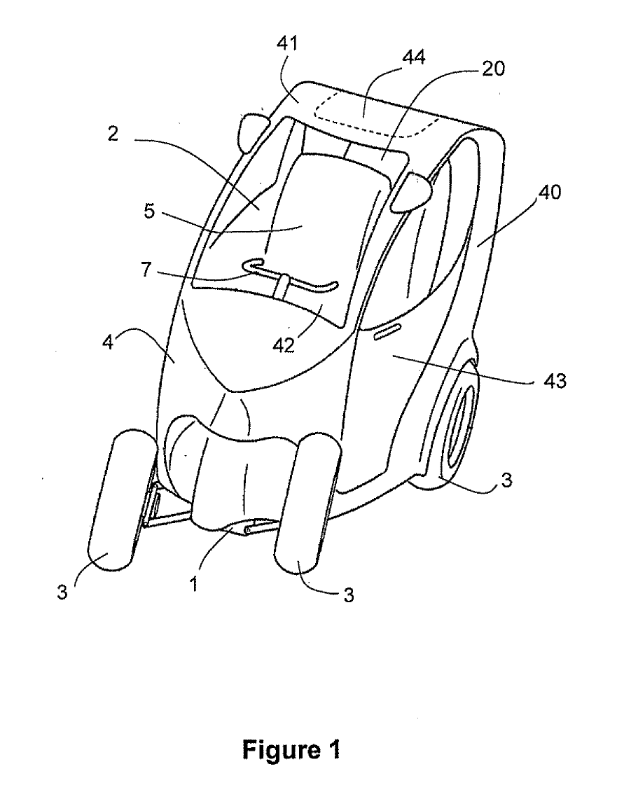

These different arrangements, as well as other characteristics and advantages of the invention, will be indicated in the following description, illustrated by FIG. 1, which represents a perspective view of a vehicle according to the invention.

As illustrated by this figure, the vehicle according to the invention comprises a chassis 1, a driving cab 2 which is integral with the latter, and four wheels 3, which are also connected to the chassis. Preferably, the wheels which are situated at the front of the vehicle are guiding wheels. The vehicle according to the invention also comprises a power unit (not represented in FIG. 1), which, by way of non-limiting example can be thermal, electrical, hybrid or of any other type.

The driving cab 2 comprises a driver's seat 5, which is the only seat, the dimensions of the driving cab being such that the vehicle can accommodate only a single person in the width direction.

According to the embodiment illustrated by FIG. 1, the driving cab 2 is thus closed by a bodywork 4 comprising lateral panels 40, a roof 41, and a front windscreen 4′2.

According to a characteristic of the invention, a door 43 is provided in each of the lateral panels 40, in order to allow the driver to access the driving cab 2 from either side of the vehicle. The doors 43 can be sliding or pivoting, their direction of opening being defined according to the criteria of accessibility and dimensions of the vehicle. According to different embodiments, these doors can be equipped with transparent panels or windows, such as to increase the visibility for the driver.

According to another characteristic of the vehicle according to the invention, the roof 41 advantageously comprises an opening panel 44. This panel, which according to different embodiments can be sliding according to an axis which is substantially parallel to the longitudinal axis of the vehicle, or pivoting around an axis which is substantially parallel to the said longitudinal axis, or perpendicular to the latter, has two main advantages. Firstly, its opening permits access to the driving cab, and in particular to the area for transporting of objects which is situated at the rear of the vehicle, for example in order to place belongings there. Secondly, in the case in which it is sliding, opening of the panel 44 permits ventilation of the passenger space of the vehicle, as well as easier access in the case when use of the vehicle involves the driver stopping and getting out many times.

In order to drive the vehicle, the driver has a steering unit 7, which in this case is a handlebar according to the embodiment illustrated by FIG. 1, and is advantageously a steering wheel according to alternative embodiments of the invention.

In order to assure correct road hold, a vehicle of this type comprises balancing means (not represented in FIG. 1), which act by simultaneous inclination of the chassis 1 (which is integral with the driving cab 2), and some or all of the wheels 3.

The vehicle comprises a series of sensors, in particular for speed, acceleration and/or inclination (not represented in FIG. 1). When the information which is provided by the said sensors (value of a specific parameter, or combination of values of all or some of the parameters measured by the said sensors) is lower than a previously defined main threshold S1, the balancing means are automatically controlled by an automatic device (not represented in FIG. 1). The vehicle also comprises switching means (not represented) which, when the information which is provided by the said sensors is higher than the main threshold S1, authorise deactivation of the automatic control of the balancing means by the automatic device. In a known manner, the automatic control of the balancing means is provided for example by means of an electric motor and a computer.

In addition, the balancing means are automatically controlled when, with the vehicle in motion, the information which is provided by the sensor(s) reaches, by decreasing, a main descending threshold S1′ which is lower than the main threshold S1, and remains lower than the said main threshold S1.

According to different versions of the vehicle according to the invention, the automatic control of the balancing means of the vehicle is thus, beyond the main threshold S1, automatically, activated, automatically deactivated, or left up to the choice of the driver whether to activate or deactivate it. Reference is then made to an automatic version of the vehicle, when the automatic control of the balancing means remains automatically active beyond the main threshold S1, and to a manual version, when the automatic control is automatically deactivated beyond the main threshold S1. It should be noted that, in this case, beyond the threshold S1, the balancing means can be controlled by the driver alone, with or without assistance. Finally, in another version of the vehicle according to the invention, in which, beyond the main threshold S1, the deactivation of the automatic control of the balancing means is left up to the choice of the driver (combined version of the vehicle), the vehicle according to the invention then comprises means for deactivation of the switching means. The latter can for example assume the form of visual information or a manual switch which is associated with an indicating lamp, which changes state when the threshold S1 is cleared.

By way of non-limiting example, when the sensor which is used to control the switching of the control of the balancing means is a speed sensor, the main threshold S1 can be set to a few tens of kilometres/hour, for example between 5 and 40 km/h, and preferably between 7 and 15 km/h.

As previously stated, this makes it possible, firstly, when the vehicle is travelling in conditions for example of limited speed, acceleration or inclination, to benefit from the automatic control of the balancing means, for optimum driving comfort. It also makes it possible, when the conditions for example of speed, acceleration or inclination are higher, to benefit from other means for control of the balancing means, such as, by way of non-limiting example, control by the driver. In this last case, the deactivation of the automatic control of the balancing means will make it possible in particular to benefit from the capacities of anticipation of the driver, for driving which is better adapted to the conditions of travel of the vehicle. As previously stated, the possibility of deactivation of the automatic control of the balancing means also makes it possible to limit the power of the electric or hydraulic actuator of the automatic device, and, in particular, to provide a low-power motor (and which therefore has a low cost), whilst maintaining the comfort and the driving advantages provided by the automatic device below the main threshold S1.

The vehicle also comprises means for positioning relative to the vertical level (or in a position which is very close to the vertical level). As previously stated, these vertical positioning means intervene substantially when the vehicle is at a standstill or is close to a standstill, as well as when the vehicle is reversing.

It also comprises means for controlling these means for positioning relative to the vertical level.

These vertical positioning means of the vehicle are controlled automatically when the information which is provided by the sensor(s) is lower than a pre-established vertical maintenance threshold S2, which is the same as, or lower than, the main threshold S1. Similarly, the means for positioning relative to the vertical level are automatically deactivated when the information which is received from the said sensor(s) is higher than the vertical maintenance threshold S2.

In addition, these means are controlled automatically when, with the vehicle in motion, the information provided by the sensor(s) reaches, whilst decreasing; a descending vertical maintenance threshold S2′ which is lower than the vertical maintenance threshold S2, and remains lower than the said vertical maintenance threshold S2.

The vehicle is also provided with a manual vertical position switch (not represented), the actuation of which automatically commands the positioning means to go to the vertical level, irrespective of the value of the information provided by the aforementioned sensor(s).

The vehicle also comprises means for locking in the vertical position or very close to the vertical level when at a standstill.

The vehicle according to the invention also comprises means for limitation of its inclination. As previously stated, these limitation means make it possible in particular to improve the dynamic performance of the vehicle during phases of driving on bends. The means for limitation of the inclination are advantageously associated with means or locking of the inclination necessary when the vehicle is approaching a tight bend, in particular at high speed, for example. The vehicle additionally comprises means for automatic control of the means for limitation of the inclination, and means for locking the latter. The means for limitation and locking of the inclination of the vehicle are controlled automatically irrespective of the method for controlling the means for balancing of the vehicle.

The vehicle additionally comprises supplementary means which increase further its comfort and safety, as well as its driving comfort. As previously stated, these additional means can be used as assistance means by the driver, for example when the automatic control of the balancing means by the said automatic device has been deactivated, beyond the main threshold S1.

Thus, according to a preferred embodiment, the vehicle comprises means which, starting from a threshold value S3 (or hardening threshold) of the speed, acceleration and/or inclination of the vehicle (or of any combination of all or some of these parameters), increase the force to be exerted on the steering unit 7 in order to provide a given variation of inclination or trajectory.

Alternatively, or simultaneously, according to the embodiment selected, the vehicle comprises means which modify the law of response of the balancing means to the movement of the steering unit 7, starting in particular from a threshold value S4 (or modification threshold) of the speed, acceleration or inclination, or of any combination of all or some of these parameters. For example, as previously described, the means which modify the law of response of the balancing means act such that, beyond the aforementioned threshold S4, a given movement of the steering unit 7 leads to variation of the inclination or trajectory of the vehicle which is greater than the resulting variation of the same movement of the steering unit 7 below the said threshold S4.

According to a preferred embodiment of the invention, the means which tend to increase the force to be exerted on the steering unit 7 and/or which modify the law of response of the balancing means, are controlled automatically, or are deactivated, depending on whether the speed, acceleration and/or inclination of the vehicle (or any combination of all or some of these parameters) are higher or lower respectively than the threshold S3 and/or S4. It should be noted that the thresholds S3 and/or S4 can be identical to the main threshold S1 previously defined, or different from the latter. Also, they may or may not be equal to one another. In all these cases, the thresholds S3 and S4 will however preferably be greater than the main threshold S1.

According to a preferred embodiment of the invention, the means for hardening of the steering (which increase the force to be exerted on the steering unit) and the means for modification of the law of respohse of the balancing means to the movements of the steering unit 7 are implemented as driving assistance means when the automatic control of the balancing means has been deactivated beyond the main threshold S1. In this case, they preferably intervene as a complement to any partial (manual) control assistance of the balancing means.

It should be noted that they can also be implemented in a fully automatic version of the vehicle according to the invention, wherein the automatic control of the balancing means is always active, irrespective of the speed, acceleration and/or inclination of this vehicle. In this case, the thresholds S3 and S4 will be greater than the straightening threshold S2.

The invention as previously described thus makes it possible to provide a vehicle in which different driving assistance means can be activated or deactivated according to travel conditions, for pleasant and safe driving conditions which are optimum irrespective of the version (manual, fully automatic or combined, of the vehicle).

However, the invention cannot be limited to the embodiments and means described in the present document, and also extends to any other equivalent means and any technically operative combination of these means. In particular, the sensors which provide the information to the switching means are not limited to the sensors for speed, acceleration and/or inclination referred to in the present description. Also, according to different variants of the invention, it is also perfectly possible to envisage the thresholds S1, S2, S3, S4 being able to vary according to climatic conditions such as rain, snow or ice, or being able to be modified by the driver. In addition, although the invention has been described here within the context of its application to a vehicle comprising wheels, it can perfectly well be applied to a vehicle which for example is provided with runners for travel on snow, or for which contact with the ground is assured by any type of means appropriate for the surface on which the vehicle is required to travel.

1. Motorised vehicle with at least three wheels which comprises:
means for balancing by inclination of at least the part of its chassis which supports the driving cab;
at least one sensor for speed, acceleration and/or inclination;
means for controlling the said balancing means automatically when the information provided by the said sensor is lower than a main threshold; and
switching means in order to authorise the deactivation of the automatic control of the said balancing means, when the information which is provided by the said sensor is higher than the said main threshold.

2. Vehicle according to claim 1, wherein the said balancing means are controlled automatically, firstly when the vehicle starts, and until the information provided by the said sensor has reached the said main threshold, and, secondly when, with the vehicle in motion, the information provided by the said sensor is higher than a main descending threshold, and, whilst decreasing, the said information reaches the said main descending threshold, the said balancing means then being controlled automatically for as long as the said information remains lower than the said main descending threshold, and until the said vehicle stops.

3. Vehicle according to claim 1, wherein it also comprises means for limitation and means for locking of its inclination, which firstly limit the angle of inclination of the inclinable elements to a maximum value, such that the vehicle does not tilt either when at a standstill or when travelling, and secondly prevent the vehicle from straightening when the angle of inclination is thus limited.

4. Vehicle according to claim 1, wherein the information which is provided by the said sensor is higher than the said main threshold, the automatic control of the said balancing means is deactivated automatically.

5. Vehicle according to claim 1, wherein, the information which is provided by the said sensor is higher than the said main threshold, the said balancing means are controlled automatically in a vehicle driving-assistance mode.

6. Vehicle according to claim 1, wherein it additionally comprises means for positioning relative to the vertical level, or to a position which is very close to the vertical level, of at least its inclinable part, as well as means for controlling automatically the said means for positioning to the vertical level, when the information which is provided by the said sensor is lower than a vertical maintenance threshold.

7. Vehicle according to claim 6, wherein the said means for positioning relative to the vertical level, or to a position which is very close to the vertical level, are controlled automatically, firstly when the vehicle is started, and until the information provided by the said sensor has reached the said vertical maintenance threshold, and secondly, when, with the vehicle in motion, the information which is provided by the said sensor is higher than a descending vertical maintenance threshold, and the said information provided reaches, whilst decreasing, the said descending vertical maintenance threshold, the said means for positioning relative to the vertical level or in a position very close to the vertical level then being controlled automatically for as long as the said information remains lower than the said descending vertical maintenance threshold, and until the said vehicle stops.

8. Vehicle according to claim 6, wherein the said means for positioning relative to the vertical are controlled automatically when the vehicle reverses.

9. Vehicle according to claim 1, wherein it comprises a manual vertical position switch, in order to command the said positioning means automatically to the vertical level, or to a position which is very close to the vertical level.

10. Vehicle according to claim 1, wherein it comprises means for locking the inclinable part of the said vehicle in a vertical position, or very close to the vertical level, when the said vehicle is at a standstill.

11. Vehicle according to claim 1, wherein it comprises a torsion bar which is integral with a steering control unit which limits the rotation of the wheels relative to the movement of the said steering control unit.

12. Vehicle according to claim 1, wherein it comprises means for partial separation of the wheels from the steering control unit of the vehicle, over a previously determined steering angle, and means for automatic control of the said partial separation means, and in that the said partial separation means are controlled automatically or are deactivated automatically, according to whether the information provided by the said sensor is respectively higher or lower than a previously determined partial separation threshold.

13. Vehicle according to claim 12, wherein the said partial separation means and the said means for automatic control of the said partial separation means consist of a torsion bar which is integral with the steering control unit.

14. Vehicle according to claim 1, comprising a driver's seat which is contained in a driving cab with dimensions such that it can accommodate only a single person in the width direction, wherein each side of the driving cab is equipped with an access door, in that the said driving cab comprises a mobile roof panel, and in that each access door and the said roof panel open and close either independently from one another, or simultaneously, two or three of them at a time.
